(19) United States
(12) Patent Application Publication
(10) Pub. No.: US 2012/0000286 A1
(43) Pub. Date: Jan. 5, 2012

(54) Measuring Stix

(76) Inventor: Devon T. Binns, (US)

(21) Appl. No.: 12/772,333

(22) Filed: Jul. 2, 2010

(51) Int. Cl. G01F 19/00

(52) U.S. Cl. 73/426

(57) ABSTRACT

My invention “The Measuring Stix” is approximately 5.5 inches in length. It is a 4-in-1 Two Headed/Sided Teaspoon “Measuring Stix”. One head/side of the “Measuring Stix” is a ¼ teaspoon measurement and the other head/side is a uniquely positioned ⅓ teaspoon measurement inside of the ½ teaspoon measurement. There is a lip inside to show the ⅓ teaspoon measurement. Two (2) ½ teaspoon measurements make one (1) full teaspoon. This product measures all four (4) teaspoon measurements (¼, ⅓, ½, 1) in one unique convenient design. These same basic design and principals apply to the matching larger sized tablespoon version. The body will have printed indicia; the printed indicia could include advertising and/or data. This product is made out of food grade plastic. “The Measuring Stick” could also be made out of any kind of metal including cooper, aluminum, steel, bronze, and any/all other metals and metal blends.

### BACKGROUND

Measuring Devices are used as a unit of volume, especially in cooking recipes, pharmaceutic prescriptions, and powdered vitamins. Two (2) examples of units of volume are commonly known as Teaspoons and Tablespoons. A tablespoon is a larger version of the teaspoon, generally with three (3) times its capacity. Teaspoons are typically sold as a four (4) piece set of individual pieces attached by a plastic ring; measuring ¼ tsp, ⅓ tsp, ½ tsp, and 1 tsp.

What is needed is a way to maximize storage space and encompass all four (4) unique measurements (¼ tsp, ⅓ tsp, ½ tsp, 1 tsp) into one (1) piece/unit.

### SUMMARY

My invention “The Measuring Stix” is approximately 5.5 inches in length but could be made to in any length. It is a 4-in-1 Two Headed/Sided Teaspoon “Measuring Stix”. I will also be making the same product with the exact same features described but sized approximately for Tablespoons, generally three (3) times more capacity than the teaspoon. One head/side of the “Measuring Stix” is a ¼ teaspoon measurement and the other head/side is a uniquely positioned ⅓ teaspoon measurement inside of the ½ teaspoon measurement. There is a lip inside to show the ⅓ teaspoon measurement. Two (2) ½ teaspoon measurements make one (1) full teaspoon. This product measures all four (4) teaspoon measurements (¼, ⅓, ½, 1) in one unique convenient design. The same basic design and principals apply to the matching tablespoon “Measuring Stix”. The body of “The Measuring Stix” will have printed indicia with the prospective company that is buying the product. The printed indicia could include advertising and/or data. This product is made out of food grade plastic as per required by the U.S Food & Drug Administration (FDA). The plastic has to have a greater purity. “The Measuring Stick” could also be made out of any kind of metal including cooper, aluminum, steel, bronze, and any/all other metals and metal blends.

### BRIEF DESCRIPTION OF THE DRAWING FIGURES

FIG. 1 is a perspective side front view of the stix

FIG. 2 is a rear view of the stix

FIG. 3 is an up-side down elevation view of the stix

FIG. 4 is a flat laying elevation view of the stix

FIG. 5 is a front view of the stix

FIG. 6 is a rear view of the stix

FIGS. 7 & 8 are side views of the unique side ⅓ tps inside of the ½ tps measurement

FIG. 9 is a side front angle view of the stix

FIG. 10 is a 45 degree front view of the stick

FIG. 11 is a close up of the ⅓ teaspoon measurement within the ½ teaspoon measurement

FIG. 12 is a close up of the ¼ teaspoon at the other end of the stix

FIG. 13 is a rear elevation view of the stick

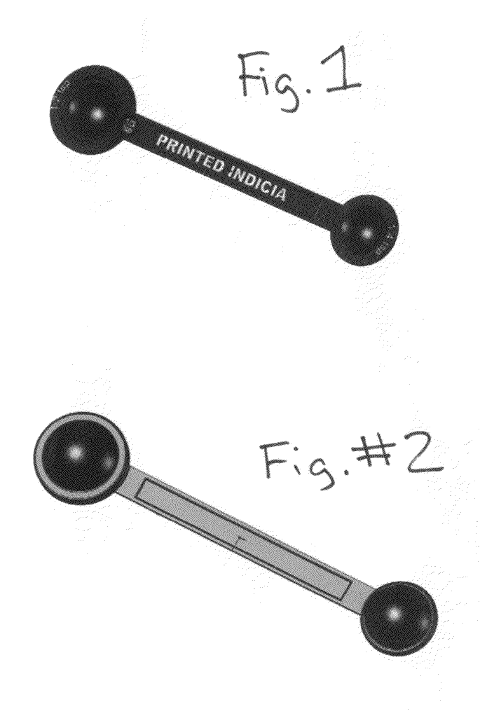

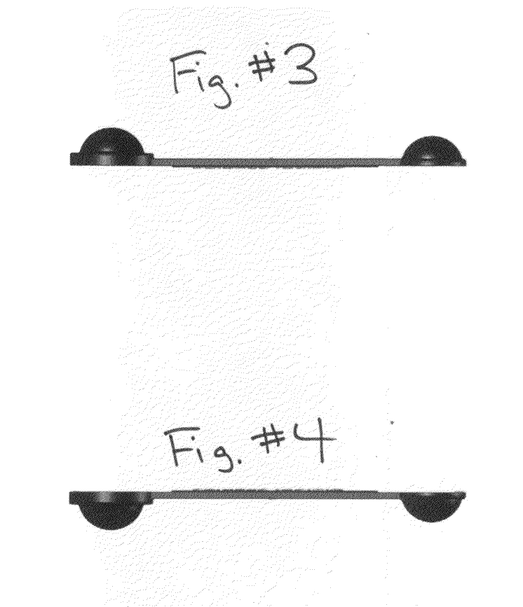

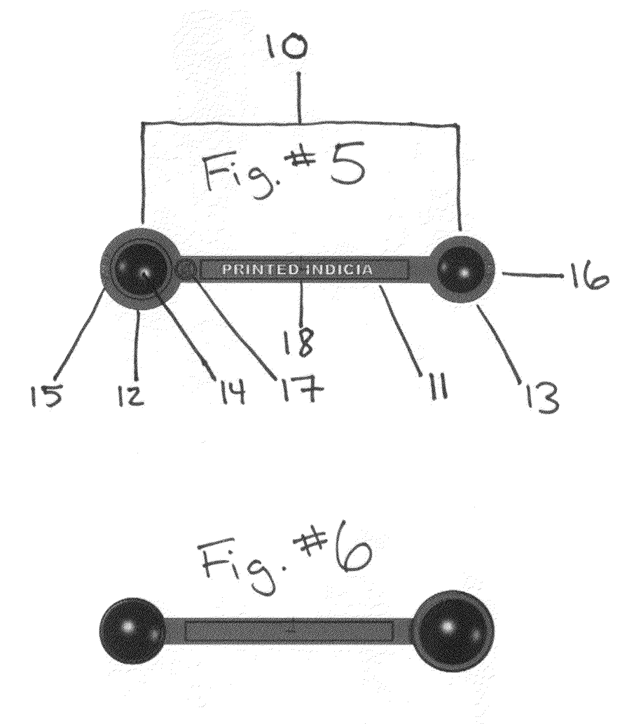

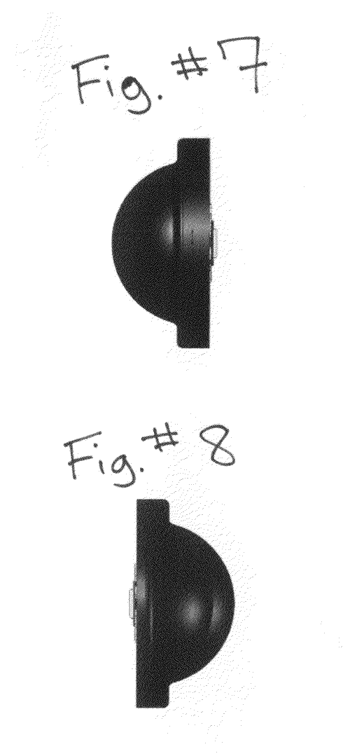

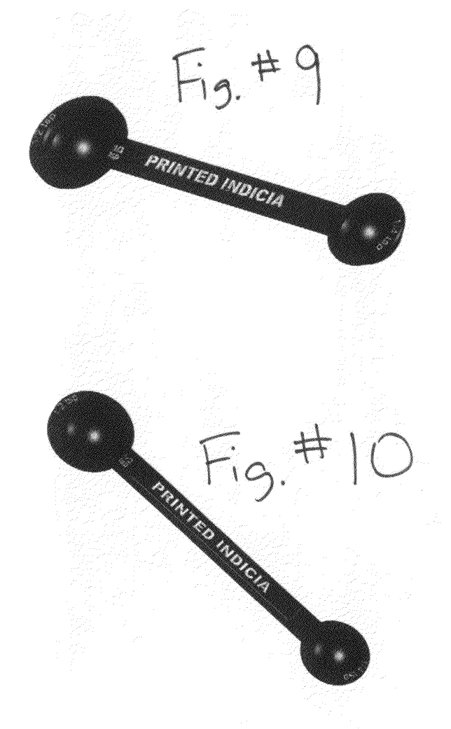

### DETAILED DESCRIPTION

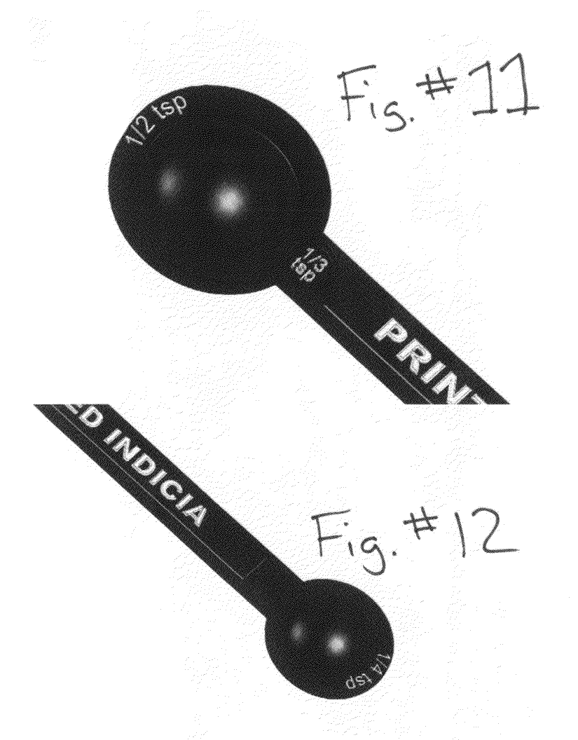

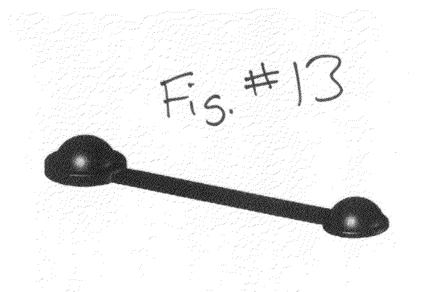

As shown in FIGS. 1 -13 (Please look in particular to FIG. 5), the “Measuring Stix” 10 (also referred to herein as “The Measuring Stix”10) “The Measuring Stix”10 has an elongate body portion 11 having two unique measuring sides 12/13. The left hand side of the “Measuring Stix” 12 has ⅓ teaspoon 14 within a ½ teaspoon 15 measurement. The right hand side of the “Measuring Stix”13 has a ¼ teaspoon measurement 16. The ⅓ teaspoon measurement is clearly defined on the “Measuring Stix” 17. The “Measuring Stix” 10 is made out of FDA approved food plastic but could be made out of any kind of metal including cooper, aluminum, steel, bronze, and any/all other metals and metal blends. The surface of the “Measuring Stix” 10 has printed indicia 18 as shown in the drawing FIGS. 1, 5, 9-12. The printed indicia 18 can be embodied as advertising, promotional information, data, and/or other suitable indicia. The printed indicia may vary based on the respective company who purchases the product.

What is claimed:

1. Two headed/sided “Measuring Stix” comprising anything disclosed, mentioned, or shown herein

2. Placing a ⅓ of a teaspoon measurement within a ½ teaspoon measurement.

3. Measuring Device for Teaspoons and Tablespoons with 2 different measurements on either side.

4. Placing Printed Indicia on the outside of the product to change based on who is purchasing

5. The above 4 claims can also be applied to the large version of “The Measuring Stix”
